(19) United States
(12) Patent Application Publication
(10) Pub. No.: US 2004/0045883 A1
(43) Pub. Date: Mar. 11, 2004

(54) Stormwater quality in-pipe filter

(76) Inventor: Richard A. Miller JR., Delaware, OH (US)

Correspondence Address: RICHARD A MILLER, JR., 4484 BAKER ROAD, DELAWARE, OH, 43015, US

(21) Appl. No.: 10/238,148

(22) Filed: Sep. 11, 2002

(51) Int. Cl. B01D 35/02

(52) U.S. Cl. 210/162; 210/459

(57) ABSTRACT

The concept of my invention, the Stormwater Quality In-Pipe Filter, is a stormwater filter that is inserted into the storm pipe itself. The device is lightweight, removes stormwater pollutants and is easy to maintain; which means the public will have access to improved stormwater quality without the large price and maintenance issues associated with many commercial stormwater quality units available today.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Storm water runoff is a form of diffused or non-point source pollution. It is caused by rainwater washing pollutants, such as particulate matter, organic matter, heavy metals, and organic toxins into receiving natural bodies of water. As a consequence, natural bodies of water that receive storm water also receive pollutants that have harmful environmental effects. The amount of pollution entering into such receiving bodies of water is related to the degree of urbanization and agricultural activity in the surrounding area and the nature of the urbanization and/or agricultural activity. Urbanization results in the paving of land with water-impermeable materials, such as concrete, upon which pollutants tend to accumulate over time. Moreover, agricultural lands with chemical and organic applications contribute to the toxins being washed into our waterways. Rain falling upon these pollutant-laden surfaces washes the pollutants into the storm water system, which are then conveyed into the receiving water body.

Due to increasing urbanization and depletion of agricultural filter strips in the USA and abroad, stormwater runoff has been identified as a significant source of pollution in receiving water bodies. In an effort to address the pollution problems posed by stormwater runoff, my invention proposes a simplified method and apparatus for removing pollutants from the storm water.

There have been many efforts to remedy this problem with the engineering design of natural types of storm runoff treatment systems (e.g., sediment ponds, and swales), as well as a host of various mechanical and chemical processes. All systems designed to remove pollutants from stormwater runoff will require maintenance at some point and time. Maintenance can often be cumbersome, time consuming and costly to the owner of said mechanisms. My invention, the Stormwater Quality In-Pipe Filter, should be relatively inexpensive to purchase, install and maintain.

### BRIEF SUMMARY OF THE INVENTION

The Storm Quality In-Pipe Filter is comprised of a predominantly HDPE (high-density polyethylene) collar with a flange and an HDPE grid elongated basket or trash trap attached. The device is placed into the receiving end (inlet) of a storm sewer pipe to capture floating debris and trash carried by the stormwater runoff. An optional commercially available fabric filter may be inserted into the grid frame and/or various commercially available pollutant capturing media sewn into the fabric filter such as hydrocarbon, chemical or organic capturing granules. It is expected that the majority of consumers will opt to have some type of fabric filter placed in the Storm Quality In-Pipe Filter.

The Storm Quality In-Pipe Filter will be inexpensive, lightweight, durable and easy to maintain with respect to most of the stormwater treating devices available on the market today while removing a substantial amount of the stormwater runoff pollutants.

### BRIEF DESCRIPTION OF THE SEVERAL VIEWS OF THE DRAWING

FIG. 1) Depicts the top view as if looking down on the device through the pipe (dashed/hidden line) in which said device has been placed. FIG. 1 also shows the external trash trap grid (half-circle elongated/tapered basket) with the fabric filter within the trash trap basket frame. Additionally, FIG. 1 shows the flange that will prevent the device from slipping into the storm pipe during water flows.

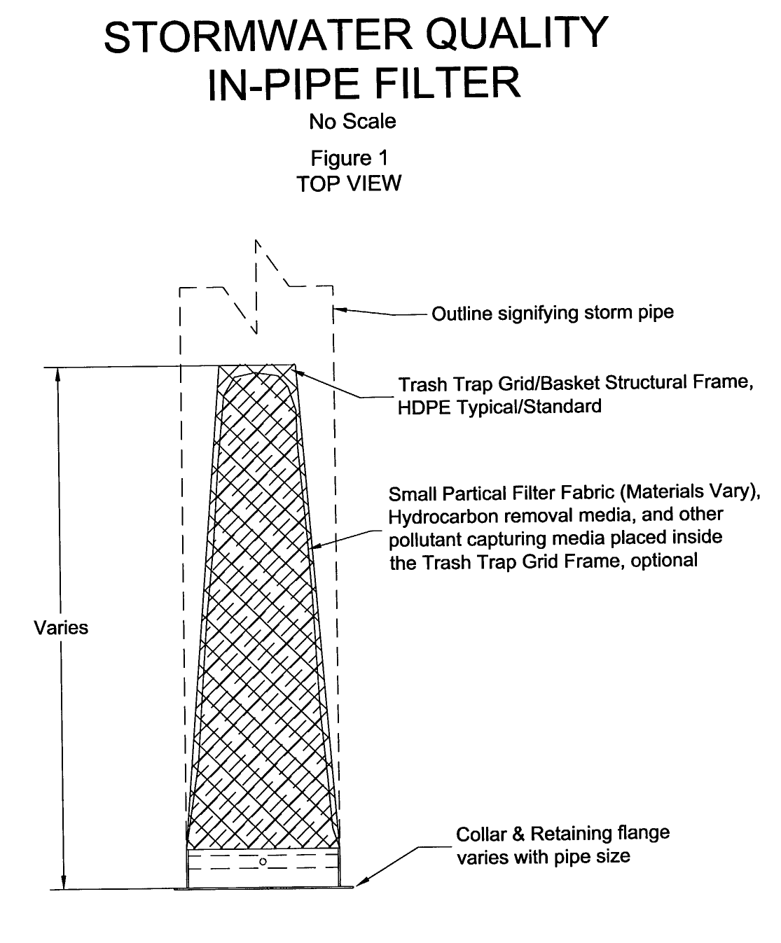

FIG. 2) Depicts the front view looking into the storm pipe in which the device has been placed. FIG. 2 shows the hidden line which signifies the inside of the storm pipe and the round collar, the horizontal HDPE covered non-corrosive steel bar with clevis for extracting the device from the storm pipe, and the half-circle trash trap/basket without a fabric filter liner.

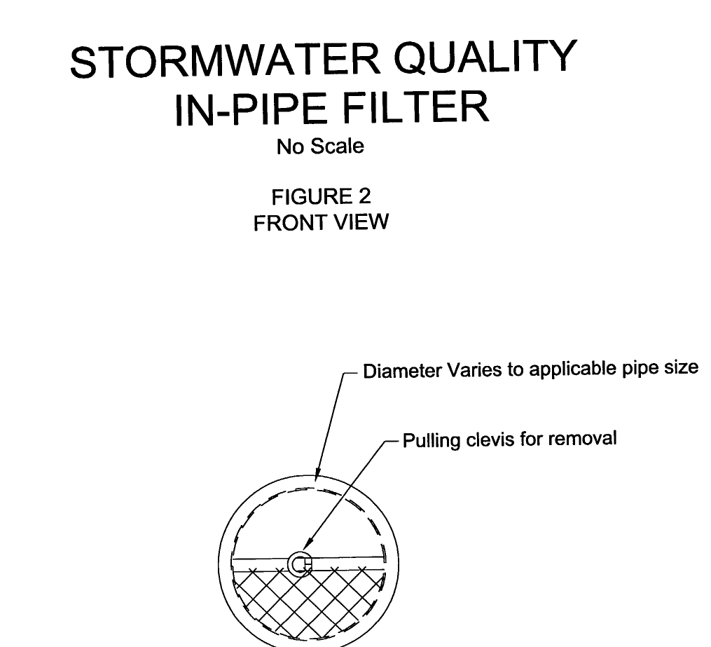

FIG. 3) Depicts a side view as if looking through the storm pipe as the tapered trash trap/basket lays on the bottom of the storm pipe consuming only one half to zero of the height/diameter of the storm pipe for which the device is placed inside of.

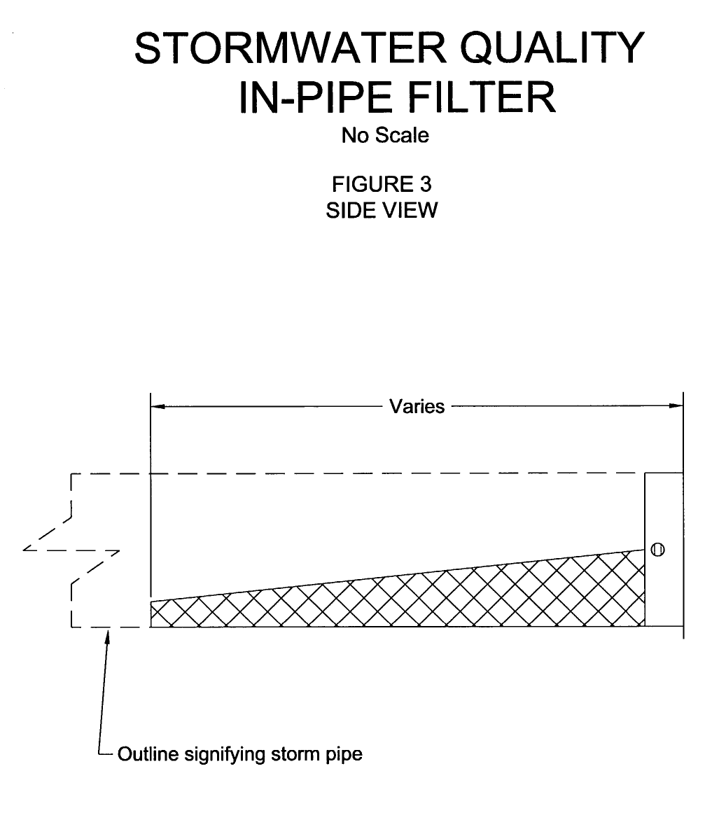

### DETAILED DESCRIPTION OF THE INVENTION

The Stormwater Quality In-Pipe Filter will be constructed of a predominantly HDPE (high-density polyethylene) frame, which consists of a full circular collar (diameter and shape varies with pipe size and type), and a half-circle elongated/tapered basket (length varies based on consumer preference and performance desired) attached to the bottom of the collar. The collar will also have a horizontal HDPE covered non-corrosive steel bar placed at the mid-point of the circle reaching from one side of the collar to the other side of the collar being in the middle of the circle of the collar. The half circle elongated/tapered basket shall be attached to the bottom portion of the collar and the HDPE covered non-corrosive steel bar placed at the mid-point of the collar circle. This becomes the frame (collar with flange, horizontal HDPE covered non-corrosive steel bar placed at the mid-point of the circle and attached elongated/tapered basket) that will be inserted into the receiving end (the end of the pipe which the water inflows as opposed to the end of the pipe which discharges the water) of a storm sewer pipe. The flange on the collar is to keep the collar and elongated basket from washing into the pipe. The horizontal HDPE covered non-corrosive steel bar placed at the mid-point of the circle of the collar will have a clevis attached to the mid-point of the bar. The clevis attached to the mid-point of the bar is for attaching a cable or chain for extracting the device from the storm pipe.

Each unit (Stormwater Quality In-Pipe Filter) shall be sized and shaped for the pipe for which the unit is designed for insertion. The frame (collar with flange and attached elongated/tapered basket) in and of itself would collect large debris flowing in stormwater such as leaves, cups, cans and other types of trash. The Stormwater Quality In-Pipe Filter may also be fitted with a variety of specifically designed media such as commercially available filter fabrics and other pollutant removing media for the removal of fine particles, hydrocarbons, chemical and organic compounds

The notion or design concept of the device is to collect pollutants from the stormwater stream within the storm sewer pipe. During the first flush or beginning of the storm the device should filter all the flow until the flow exceeds one half the pipe flow level or the capacity of the filter. At such time the portion of the pipe flow exceeding one half the pipe or filter capacity will flow over the horizontal HDPE covered non-corrosive steel bar placed at the mid-point of the circle of the collar and by-pass the filter device. It is understood that the more particles/pollutants captured in the filter unit will reduce the filter and pipe capacity forcing more of the larger flows over the by-pass (horizontal steel bar and half circle filter basket), however, much of the smaller storm event flows and first flush should be filtered flows.

Maintenance of the Stormwater Quality In-Pipe Filter will consist of extracting the filter frame and removing the captured pollutants and the filter media (optional) into a collection receptacle or vactor truck, installing new filter media (optional) and reinserting the device into the storm pipe.

The embodiments of the invention in which an exclusive property or privilege is claimed are defined as follows:

1. A basket filter inserted into the inlet end of a stormwater pipe for removing pollutants carried by the stormwater,
(a) a basket filter, an elongated half circle shape that is conical or tapered from the opening and narrowing into the pipe away from the opening;
(b) a basket filter, frame, has strength such that will allow placement of a fabric filter sock made of commercially available materials attached to the frame;
(c) a filter sock which may vary in density for selection of pollutant particle size the individual filter sock is designed specifically to capture; and
(d) a filter sock which may have commercially available pollutant removing compounds sewn in for removal of other specified stormwater pollutants.

2. The apparatus of claim 1, shall consist of a circular collar with flange which will fit inside the storm pipe and for connecting the filter basket to, which will prevent said filter basket from washing into the storm pipe.

3. The apparatus of claim 1, shall have a horizontal steel bar/rod placed in the center of the circular collar with flange extending through from one side of the collar to and through the other side of the collar for the purpose of affixing the upper portion of the basket and for attaching a clevis for removal of said apparatus from the storm pipe.

4. The filter basket of said apparatus of claim 1, shall occupy the lower/bottom half of the storm pipe when inserted so to allow the portion of the stormwater stream flow that exceeds the filtering capacity of the apparatus to flow over the filter and horizontal bar through the top/open portion of the storm pipe inlet.

5. The apparatus of claim 1, shall vary in size and shape, including diameter, circular or elliptical and the length of basket to accommodate the various storm pipe sizes and shapes and the consumers design specification preferences.
